(19) United States
(12) Patent Application Publication
(10) Pub. No.: US 2020/0394668 A1
(43) Pub. Date: Dec. 17, 2020

(54) SYSTEM AND METHOD FOR DETERMINING VEHICLE FUELING BEHAVIOR

(71) Applicant: Honda Motor Co., Ltd., Tokyo (JP)

(72) Inventors: Ting Zhang, Zhejiang (CN); Kiyotaka Kawashima, Los Angeles, CA (US)

(21) Appl. No.: 16/441,482

(22) Filed: Jun. 14, 2019

(51) Int. Cl. G06Q 30/02; G06Q 50/06

(52) U.S. Cl. CPC G06Q 30/0205; B60K 2015/03217; G06Q 50/06

(57) ABSTRACT

A system and method for determining vehicle fueling behavior that include receiving sensor data associated with an occurrence of a fueling event associated with fueling of a vehicle and determining a current geo-location of the vehicle based on determining that the fueling event is occurring. The system and method also include determining a fueling station that is being utilized during the fueling event based on the current geo-location of the vehicle. The system and method further include computing at least one fueling behavior pattern based on analyzing data associated with the fueling station and the fueling event.

### BACKGROUND

Certain vehicle related purchasing behaviors may be analyzed by third parties such as vehicle manufacturers, vehicle sales establishments, and/or other good and service providers to determine certain consumer behaviors that may be utilized to predict certain purchases. For example, analyzing behaviors with respect to a particular vehicle operator may enable third parties to determine if the vehicle operator (e.g., owner, driver) may be a potential candidate to purchase a certain type of vehicle. Accordingly, the third party may determine to market certain types of vehicles to the vehicle operator based on behaviors exhibited by the vehicle operator.

### BRIEF DESCRIPTION

According to one aspect, a computer-implemented method for determining vehicle fueling behavior that includes receiving sensor data associated with an occurrence of a fueling event associated with fueling of a vehicle and determining a current geo-location of the vehicle based on determining that the fueling event is occurring. The computer-implemented method also includes determining a fueling station that is being utilized during the fueling event based on the current geo-location of the vehicle. Data is stored that is associated with the fueling station and the fueling event. The computer-implemented method further includes computing at least one fueling behavior pattern based on analyzing the data associated with the fueling station and the fueling event.

According to another aspect, a system for determining vehicle fueling behavior that includes a memory storing instructions when executed by a processor cause the processor to receive sensor data associated with an occurrence of a fueling event associated with fueling of a vehicle and determine a current geo-location of the vehicle based on determining that the fueling event is occurring. The instructions also cause the processor to determine a fueling station that is being utilized during the fueling event based on the current geo-location of the vehicle. Data is stored that is associated with the fueling station and the fueling event. The instructions further cause the processor to compute at least one fueling behavior pattern based on analyzing the data associated with the fueling station and the fueling event.

According to still another aspect, a non-transitory computer readable storage medium storing instructions that when executed by a computer, which includes a processor perform a method, the method includes receiving sensor data associated with an occurrence of a fueling event associated with fueling of a vehicle and determining a current geo-location of the vehicle based on determining that the fueling event is occurring. The method also includes determining a fueling station that is being utilized during the fueling event based on the current geo-location of the vehicle. Data is stored that is associated with the fueling station and the fueling event. The method further includes computing at least one fueling behavior pattern based on analyzing the data associated with the fueling station and the fueling event.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for determining fueling behavior with respect to a vehicle according to an exemplary embodiment of the present disclosure;

FIG. 2 is a schematic view of a plurality of modules of a fueling behavior application for determining fueling behavior with respect to the vehicle according to an exemplary embodiment of the present disclosure;

FIG. 3 is a process flow diagram of a method of updating the vehicle fueling event log with data associated with a determined fueling station and an associated fueling event according to an exemplary embodiment of the present disclosure;

FIG. 4 is a process flow diagram of a method of computing a fueling behavior pattern and analyzing the fueling behavior pattern according to an exemplary embodiment of the present disclosure; and

FIG. 5 is a process flow diagram of a method for determining vehicle fueling behavior according to an exemplary embodiment of the present disclosure

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “vehicle,” as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

A “vehicle system,” as used herein may include, but are not limited to, any automatic or manual systems that may be used to enhance the vehicle, driving and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, among others.

### I. System Overview

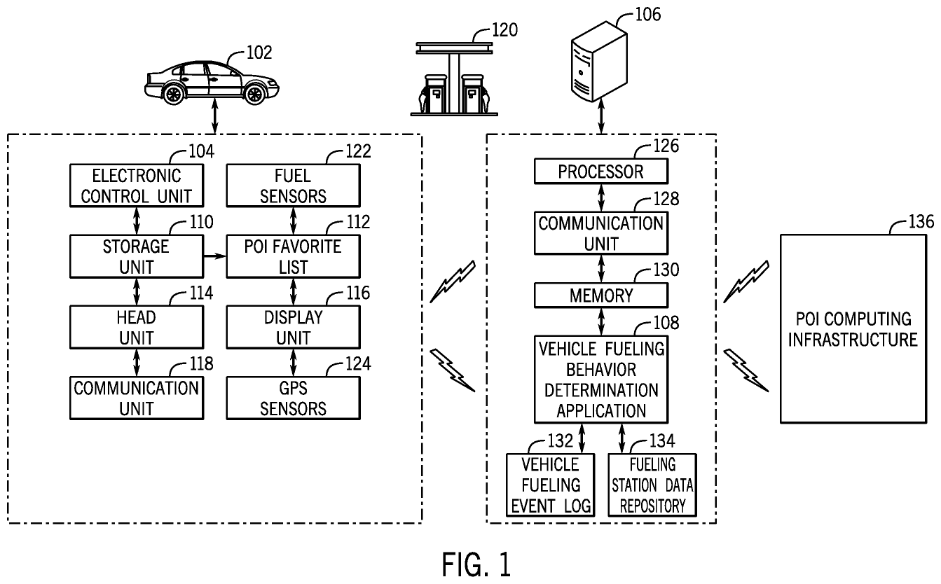

Referring now to the drawings, wherein the showings are for purposes of illustrating one or more exemplary embodiments and not for purposes of limiting the same, FIG. 1 is a schematic view of an exemplary operating environment 100 for determining fueling behavior with respect to a vehicle 102 according to an exemplary embodiment of the present disclosure.

As shown, the operating environment 100 may include the vehicle 102 that may include a plurality of components that may be operably controlled by an electronic control unit 104 (ECU 104) of the vehicle 102. The vehicle 102 may be configured to communicate with an externally hosted computing infrastructure (external server) 106 that may be managed by a vehicle manufacturer (OEM) or a third-party entity (e.g., vehicle dealership, service provider). As discussed below, the ECU 104 and/or the external server 106 may be configured to execute a vehicle fueling behavior determination application (fueling behavior application) 108 that may be executed to compute one or more fueling behavior patterns with respect to the vehicle 102 that may be associated with an operator (e.g., owner, driver) of the vehicle 102.

In an exemplary embodiment, the fueling behavior application 108 may be configured to execute logic that may enable the application 108 to receive sensor data from one or more sensors of the vehicle 102 to determine if a fueling event is taking place. The fueling event may be determined to take place when the vehicle 102 is being fueled. Upon determining that the fueling event is taking place, the fueling behavior application 108 may be configured to communicate with sensors of the vehicle 102 to determine a current (e.g., real-time) geo-location of the vehicle 102. The current geo-location of the vehicle 102 may be analyzed to determine a fueling station 120 that may be located at a matching geo-location or that may be located at a predetermined distance (e.g., 3000 feet) of the current geo-location of the vehicle 102. As discussed below, the application 108 may thereby determine that the fueling station 120 is being utilized to fuel the vehicle 102.

In one or more embodiments, the application 108 may be configured to store the determined fueling station 120. The application 108 may additionally be configured to determine and store a fueling station vendor (e.g., brand name corporation name, business name) that is determined to own and/or operate the fueling station 120, a time stamp (e.g., date and time) associated with the fueling event at the fueling station 120, a remaining mileage range (e.g., value) of the vehicle 102 based on a distance that the vehicle 102 may be able to travel based on a level of fuel that remains within one or more fuel tanks (not shown) of the vehicle 102, and/or remaining fuel levels (e.g., values) of one or more fuel tanks of the vehicle 102 upon the determination that the vehicle 102 is being fueled.

As discussed below, the fueling behavior application 108 may be configured to access and analyze stored data associated with each fueling event that may be stored over a course of time to compute one or more fueling behavior patterns that may be based on one or more fueling stations 120 and/or one or more fueling station vendors that may be utilized to fuel the vehicle 102. Additionally, the one or more fueling behavior patterns may be based on stored time stamps associated with the respective fueling events, the remaining mileage ranges and/or the remaining fuel levels as determined by the application 108.

As discussed below in more detail, the one or more fueling behavior patterns may include data points that pertain to purchasing patterns with respect to one or more particular fueling stations 120, one or more particular fueling station vendors and/or fueling habits that may be related to a frequency of fueling, remaining mileage ranges of the vehicle 102, and/or remaining fuel levels of the fuel tank(s) of the vehicle 102 that may be analyzed by the application 108, the OEM, and/or the third-party entity to classify the operator as a potential electric vehicle buyer.

In particular, such data may be analyzed to determine if the operator is prone to following one or more routines with respect to fueling of the vehicle 102. Such routines may be associated with visiting particular fueling stations 120 based on the operator's preference (e.g., based on location, facility, service, convenience, etc.), particular fueling stations 120 owned/operated by particular fueling station vendors to fuel the vehicle 102 that may be favored by the operator (e.g., based on price, quality, convenience, service, etc.). Such routines may also be associated with a frequency of fueling of the vehicle 102 and/or fueling of the vehicle 102 with similar remaining mileage ranges and/or similar remaining fuel levels of the vehicle 102.

In some embodiments, if a predetermined number of routines may be determined by the application 108, such routines may be used to by the application 108 to classify the operator of the vehicle 102 as a potential electric vehicle buyer. Such a classification may enable the application 108, the OEM, and/or the third-party entity to provide marketing, promotions, and/or information to the operator as a potential electric vehicle buyer. It is appreciated that the fueling behavior pattern may be analyzed by the application 108, the OEM, and/or the third-party entity to determine additional data that may be utilized to provide marketing, promotions, and/or information to the operator for additional goods and services that may or may not be related to the potential purchase of an electric vehicle.

As an illustrative example, the fueling behavior application 108 may be configured to determine numerous fueling events that may occur over a predetermined period of time (e.g., six months). Upon the determination of each of the fueling events, the application 108 may be configured to determine one or more fueling stations 120 that may be utilized by the operator based on determined respective geo-locations of the vehicle 102. The application 108 may also be configured to determine respective time stamps (e.g., date and time) associated with respective fueling events, remaining mileage ranges of the vehicle 102 determined at the start of respective fueling events, and/or remaining fuel levels of the vehicle 102 determined at the start of respective fueling events.

With respect to the illustrative example, the application 108 may store respective data and may analyze the data after the predetermined period of time to compute one or more fueling behavior patterns associated with the operator of the vehicle 102. The OEM and/or third party entity may further utilize the application 108 to analyze the fueling behavior pattern(s) to determine if operator is prone to following a predetermined number of routines with respect to fueling of the vehicle 102. In certain circumstances, if a predetermined number of routines are determined to be followed, such routines may be used to classify the operator of the vehicle 102 as a potential electric vehicle buyer. As discussed, such a classification may enable the application 108, the OEM, and/or the third-party to provide marketing, promotions, and/or information to the operator as a potential electric vehicle buyer.

With reference to the vehicle 102, the ECU 104 may be configured to execute one or more applications including but not limited to the fueling behavior application 108. The ECU 104 may also be configured to execute one or more operating systems, vehicle system and subsystem executable instructions, vehicle sensor logic, and the like. In one or more embodiments, the ECU 104 may include a microprocessor, one or more application-specific integrated circuit(s) (ASIC), or other similar devices.

The ECU 104 may also include respective internal processing memory, an interface circuit, and bus lines for transferring data, sending commands, and communicating with the plurality of components of the vehicle 102. In one or more configurations, the ECU 104 may include a respective communication device (not shown) for sending data internally to components of the vehicle 102 and communicating with externally hosted computing systems (not shown) (e.g., external to the vehicle 102). Generally the ECU 104 may communicate with a storage unit 110 to execute one or more applications, operating systems, vehicle systems and subsystem user interfaces, and the like that are stored on the storage unit 110.

In one or more embodiments, the storage unit 110 may be configured to store a point of interest favorite list (P01 favorite list) 112 that may be populated based on inputs that may be provided by the operator of the vehicle 102. In particular, the P01 favorite list 112 may be updated by the ECU 104 based on a reception of an input by the operator (e.g., on a user interface) that a particular point of interest such as a favorite fueling station 120 is to be stored as a favorite point of interest. The P01 favorite list 112 may be utilized by a navigation system (not shown) of the vehicle 102 to quickly input the point(s) of interest as a destination in order to provide driving directions and/or traffic information related to a path of travel to the favorite point(s) of interest. In one embodiment, the application 108 may be configured to access and analyze the P01 favorite list 112 to determine one or more fueling stations that may be favored and/or frequently utilized by the operator to fuel the vehicle 102.

In an exemplary embodiment, the ECU 104 may also be operably connected to a head unit 114 of the vehicle 102. The head unit 114 may be configured to execute one or more application, application interfaces, and/or to communicate with one or more components of the vehicle 102 to provide one or more interfaces to the operator and/or one or more additional occupants within the vehicle 102. In one embodiment, the head unit 114 may operably control and may be operably connected to a display unit 116 within the vehicle 102.

The head unit 114 may operably control the display unit 116 to present one or more interfaces of the fueling behavior application 108 within the vehicle 102. In one embodiment, the display unit 116 may include a display screen (not shown) that may be positioned upon a center stack console (not shown) of the vehicle 102. However, in additional configurations, the display unit 116 may be configured as one or more display screens that may be alternatively or additionally provided in one or more formats, including, but not limited to, a dash board display, a seat back/cushion display, a pop-up display, a head-up display, a head-mounted display, and a portable device display.

In one embodiment, the one or more interfaces of the fueling behavior application 108 may include one or more application settings interfaces that may be presented to the operator of the vehicle 102 through the display unit 116. The one or more application settings interfaces may enable the operator to prohibit the sharing of geo-location information associated with the vehicle 102 based on the operator's preference at one or more points in time.

In one embodiment, the one or more interfaces of the fueling behavior application 108 may also include one or more fueling behavior interfaces that may also be presented to the operator of the vehicle 102 through the display unit 116. The one or more fueling behavior interfaces may be presented to allow the operator to view and analyze data pertaining to one or more fueling behavior patterns that may be associated with the operator. In another embodiment, the one or more interfaces of the fueling behavior application 108 may additionally include one or more promotional interfaces that may be presented to the operator of the vehicle 102. The one or more promotional interfaces may be presented with promotional information pertaining to the purchase of one or more goods and/or services. Such promotional information may be based on data that may be provided by the OEM and/or the third party entity upon analysis of one or more fueling behavior patterns that may be associated with the operator of the vehicle 102.

The one or more promotional interfaces may additionally include one or more uniform resource locator (URL) links that may be selected upon disablement of the vehicle 102 by the operator of the vehicle 102 to access one or more websites, applications, and/or media (e.g., video, audio) that may be associated with the promotional information. For example, the application 108 may provide one or more promotional interfaces with URL links that may be associated with a sale of one or more electric vehicle models upon classifying the operator as a potential electric vehicle buyer based on the analysis of one or more fueling behavior patterns associated with the operator of the vehicle 102.

In an exemplary embodiment, the ECU 104 may additionally be operably connected to a communication unit 118 of the vehicle 102. The communication unit 118 may communicate with one or more components of the operating environment 100 and/or additional systems and components outside of the operating environment 100. The communication unit 118 may include, but is not limited to, one or more transceivers (not shown) of the vehicle 102 and additional components (not shown) that may be utilized for wired and wireless computer connections and communications via various protocols with a portable device(s) (not shown) that may be carried by the operator and may be located within a (predetermined) communicable range with the communication unit 118 of the vehicle 102. For example, the communication unit 118 may be utilized for wired and wireless computer connections that may include an active computer connection with portable device(s) that may be previously paired to the vehicle 102.

In one embodiment, the communication unit 118 may be configured to communicate with the external server 106 through an internet cloud (not shown). As discussed below, the communication unit 118 may be configured to send and receive data that may be analyzed, accessed, and/or stored by the fueling behavior application 108. For example, the communication unit 118 may be configured to send data pertaining to one or more geo-locations of the vehicle 102 to be stored on the external server 106 and utilized by the application 108.

In an exemplary embodiment, the ECU 104 may be operably connected to fuel sensors 122 of the vehicle 102. In one embodiment, the fuel sensors 122 may be configured to determine a real-time level (e.g., volume, amount) of fuel that is stored within the fuel tank(s) of the vehicle 102. The fuel sensors 122 may additionally be configured to determine when a fueling event is occurring (e.g., when the vehicle 102 is being fueled) based on real-time sensing of an increase in the level of fuel within the fuel tank(s).

Additionally, the fuel sensors 122 may be configured to determine the remaining mileage range of the vehicle 102 based on the level of fuel within the fuel tank(s), an average speed of the vehicle 102 over a predetermined period of time, and/or an average RPM of an engine (not shown) of the vehicle 102 over the predetermined period of time. As discussed below, the application 108 may be configured to communicate with the fuel sensors 122 to determine when the fueling event is occurring. The fuel sensors 122 may also provide additional data to the application 108 that may pertain to the remaining mileage range, and/or a remaining fuel level of the vehicle 102 upon the determination that the vehicle 102 is being fueled.

In one embodiment, the application 108 may evaluate data pertaining to a determination of the fueling event and may thereby determine the current geo-location of the vehicle 102 at the time of the fueling event. In particular, the determination that the fueling event is occurring may be utilized by the application 108 to communicate with the GPS sensors 124 of the vehicle 102 to determine the current geo-location of the vehicle 102. As discussed below, the current geo-location of the vehicle 102 may be further analyzed to determine the fueling station 120 that is utilized to fuel the vehicle 102.

In particular, the GPS sensors 124 may be configured as global positioning sensors that may be configured to provide global positioning coordinates (GPS coordinates) and/or differential global positioning coordinates (DGPS coordinates) that may be analyzed by the ECU 104 and/or the application 108 to determine corresponding geo-locations of the vehicle 102. The geo-locations may include particular coordinate values (geo-locational coordinates) that may be based on a geographic coordinate reference system. In one embodiment, the geo-locations of the vehicle 102 may be included as geo-locational coordinates that may pertain to latitude and longitude based geographical coordinates that may be specified in decimal degrees.

As discussed in more detail below, the fueling behavior application 108 may analyze the current geo-location of the vehicle 102 to determine the fueling station 120 that is being utilized to fuel the vehicle 102 upon receiving data associated with the occurrence of the fueling event from the fuel sensors 122. In particular, the fueling behavior application 108 may determine if a fueling station 120 is located at the current geo-location of the vehicle 102. In other words, the fueling behavior application 108 may determine if the current geo-location of the vehicle 102 matches geo-locational coordinates that pertain to a geo-location of a particular fueling station 120.

In circumstances that the current geo-location of the vehicle 102 is not determined to be exactly matching with geo-locational coordinates of a particular fueling station 120, the application 108 may be configured to determine if one or more fueling stations 120 may be located within a predetermined distance (e.g., 1000 feet) of the current geo-location of the vehicle 102. As discussed below, the application 108 may be configured to determine and store adjusted geo-locational coordinates that pertain to an adjusted current geo-location of the vehicle 102 that are associated with the current geo-location of the vehicle 102. Stated differently, the current geo-locational coordinates that pertain to the current geo-location of the vehicle 102 as determined by the GPS sensors 124 may be adjusted to match the geo-locational coordinates of a particular fueling station 120 that is being utilized to fuel the vehicle 102 and may be stored along with associated geo-locational coordinates of the current geo-location of the vehicle 102.

As an illustrative example, in a circumstance in which the vehicle 102 is located within a crowded environment that may include numerous points of interest (e.g. stores, restaurants, office buildings) that may be located within a predetermined distance of the current geo-location of the vehicle 102, the current geo-location as determined by the GPS sensors 124 may not exactly match with geo-locational coordinates of the fueling station 120 that is being utilized to fuel the vehicle 102. The application 108 may thereby determine the geo-locational coordinates of the fueling station 120 and may thereby determine and store adjusted geo-locational coordinates that pertain to the adjusted current geo-location of the vehicle 102 that matches the geo-locational coordinates of the fueling station 120. The adjusted geo-locational coordinates may be associated with the current geo-location of the vehicle 102. Accordingly, during subsequent trips to the fueling station 120, the application 108 may retrieve the stored adjusted geo-locational coordinates based on the geo-locational coordinates of the current geo-location of the vehicle 102 to efficiently determine that the vehicle 102 is located at the particular fueling station 120 based on the current geo-location of the vehicle 102.

In one embodiment, if more than one fueling station 120 is located within the predetermined distance of the current geo-location of the vehicle 102, the application 108 may be configured to analyze the POI favorite list 112 to determine if the vehicle 102 is being fueled at a particular fueling station 120 that may be previously selected as a point of interest that is favored by the operator of the vehicle 102. Accordingly, the application 108 may analyze the fueling station 120 as a favorite point of interest and may determine that the vehicle 102 is being fueled at the particular fueling station 120 that is within the predetermined distance of the current geo-location of the vehicle 102.

In another embodiment, the application 108 may be configured to communicate with the portable device(s) that may be carried by the operator that may be used to provide electronic payment for fuel to determine a particular fueling station 120 and associated fueling station vendor that is being utilized to fuel the vehicle 102. In an additional embodiment, the application 108 may be configured to communicate with a credit card and/or banking institution that may be linked by the operator (via one or more interfaces of the application 108) and may be utilized to provide electronic payment for fuel to determine a particular fueling station 120 and associated fueling vendor that is being utilized to fuel the vehicle 102 if more than one fueling station 120 is located within the predetermined distance of the current geo-location of the vehicle 102.

In one or more configurations, in circumstances that a particular fueling station 120 is determined to be utilized to fuel the vehicle 102 when more than one fueling station 120 is determined to be located within the predetermined distance of the current geo-location of the vehicle 102, the application 108 may determine if the geo-locational coordinates of the fueling station 120 match the current geo-location of the vehicle 102. If it is determined that the geo-locational coordinates of the fueling station 120 do not exactly match the current geo-location of the vehicle 102 as determined by the GPS sensors 124, the application 108 may be configured to store data associated with adjusted geo-locational coordinates that are associated with current geo-location of the vehicle 102 and that match the geo-location of the fueling station 120. Accordingly, during subsequent trips to the fueling station 120, the application 108 may retrieve the stored adjusted geo-locational coordinates based on the geo-locational coordinates of the current geo-location of the vehicle 102 to efficiently determine that the vehicle 102 is located at the particular fueling station 120 based on the current geo-location of the vehicle 102.

With particular reference to the external server 106, in an exemplary embodiment, the external server 106 may include a processor 126 that may operably control one or more components of the external server 106. In some configurations, the processor 126 may be configured to execute the fueling behavior application 108. The processor 126 may be operably connected to a communication unit 128 of the external server 106. The communication unit 128 may include one or more network interface cards (not shown) that may be configured to connect to one or more computing systems (e.g., through the internet cloud) including, but not limited to, the ECU 104 of the vehicle 102. In one embodiment, the communication unit 128 may be configured to send and receive data with the communication unit 118 of the vehicle 102 to facilitate the collection of fueling sensing data and real-time geo-location information from the vehicle 102 and/or to send and receive additional data to and from the vehicle 102.

In one configuration, the processor 126 may be operably connected to a memory 130 of the external server 106. The memory 130 may be configured to store data files associated with one or more applications, operating systems, vehicle systems, subsystem user interfaces, including but not limited to data files of the fueling behavior application 108. In particular, the memory 130 may be configured to store a vehicle fueling event log 132 that may be accessed and utilized by the fueling behavior application 108. In one embodiment, the vehicle fueling event log 132 may be configured as a relational database/data store that may include various records that may pertain to fueling events that may be collected from the vehicle 102.

As discussed below, the application 108 may access the vehicle fueling event log 132 to update the vehicle fueling event log 132 with current geo-location information that may pertain to a current geo-location of the vehicle 102 during the determination of a fueling event. The vehicle fueling event log 132 may also be updated with a determined fueling station 120, fueling station vendor, adjusted geo-location coordinates that may be associated with the current geo-location of the vehicle 102 and adjusted to account for the exact geo-locational coordinates of the fueling station 120, and a time stamp associated with the occurrence of a fueling event at the fueling station 120. Additionally, the vehicle fueling event log 132 may be updated with information pertaining to a remaining mileage ranges of the vehicle 102 and/or a remaining fuel levels of one or more fuel tanks of the vehicle 102 upon the determination that fueling event is occurring.

As discussed below, the application 108 may be configured to access the vehicle fueling event log 132 and to retrieve records of a plurality of fueling events that may take place over a predetermined period of time and/or during a duration of time that a predetermined distance has been traveled by the vehicle 102. The application 108 may analyze the data within the records of the plurality of fueling events to compute one or more fueling behavior patterns that may include data points associated with determined fueling stations 120, fueling station vendors, time stamps associated with the respective fueling events, the remaining mileage ranges determined at the start of the fueling events and/or the remaining fuel levels determined at the start of the fueling events.

In an exemplary embodiment, the one or more fueling behavior patterns may be further analyzed by the application 108 to determine if one or more routines that may be followed by the operator with respect to the fueling behavior of the operator. As discussed below, the application 108 may analyze the fueling behavior pattern(s) to determine if one or more routines may be followed with respect to the fueling behavior of the operator at particular fueling stations 120, at particular fueling stations 120 owned/operated by specific fueling vendors, at particular time frames (e.g., morning, afternoon, evening, particular day of the week), at particular frequencies (e.g., every 7 days, every 300 miles), with a particular range of remaining mileage of the vehicle 102 and/or remaining fuel amount of the vehicle 102. If the application 108 determines that a predetermined number of routines are followed by the operator, the application 108 may further classify the operator of the vehicle 102 as a potential electric vehicle buyer. Such a classification may enable the OEM or the third-party entity to provide marketing, promotions, and/or information to the operator as a potential electric vehicle buyer.

In one or more embodiments, the memory 130 may store a fueling station data repository 134. The fueling station data repository 134 may be configured as a relational database/data store that may include various records that may pertain to fueling station data that may be utilized by the application 108 to determine an identity (e.g., name) of one or more fueling stations 120, the geo-locational coordinates of one or more fueling stations 120, and the identify of fueling station vendors that own/operator one or more fueling stations 120.

In some configurations, the fueling station data repository 134 may also include data pertaining to price trends of various types and/or levels (e.g., octane levels) of fuel that are charged by the one or more fueling vendors and/or at one or more particular fueling stations 120 owned and/or operated by particular fueling vendors. In some embodiments, the price trends may be analyzed by the application 108, the OEM, and/or the third party entity to determine routines associated with the operator's pricing preferences to utilize fueling station(s) 120 owned/operated by one or more particular fueling vendors. For example, such price trends may be analyzed by the application 108 to categorize one or more fueling vendors as discount fueling vendors that (on average) charge less for various types and/or levels of fuel in one or more areas (e.g., country, state, city, region, etc.) and may be preferred by the operator to fuel the vehicle 102.

In one embodiment, the fueling station data repository 134 may be updated continually with fueling station data pertaining to the one or more fueling stations 120 (e.g., station names, geo-locational coordinates of the respective fueling stations 120) one or more fueling station vendors (e.g., vendor names), one or more particular fueling stations operated by particular fueling vendors, and the real-time pricing trends of various types and/or levels (e.g., octane levels) of fuel that are charged by the one or more fueling vendors and/or at one or more particular fueling stations 120. In particular, the fueling station data repository 134 may be continually updated based on communication between the external server 106 and a POI computing infrastructure 136 to ensure that the application 108 is provided real-time and up to date information with respect to geo-locational coordinates of one or more new fueling stations 120, renaming or rebranding of one or more current fueling stations 120, and/or fueling vendors that own/operate one or more fueling stations 120.

In one embodiment, the POI computing infrastructure 140 may include one or more computing devices that may communicate with one or more third party entities, that may include, but may not be limited to, fueling station vendors, application program develops/providers (e.g., application program interface developers/providers), and/or the OEM to provide real-time and up to fueling station data pertaining to one or more fueling stations 120. As discussed below, the fueling station data may be continually updated upon the fueling station data repository 134 and analyzed by the application 108 to determine information that pertains to one or more fueling stations 120. Such information may be further analyzed to compute the one or more behavior patterns to further determine if one or more routines are followed by the operator.

### II. The Vehicle Fueling Behavior Determination Application and Related Methods

The general functionality of the fueling behavior application 108 will now be discussed in more detail with respect to methods that may be executed by the application 108. In an exemplary embodiment, the fueling behavior application 108 may be fully or partially executed by the ECU 104 and/or the head unit 114 of the vehicle 102. Additionally or alternatively, the fueling behavior application 108 and one or more features and systems of the application 108, may be fully or partially executed by the processor 126 of the external server 106. The fueling behavior application 108 may utilize the communication unit 118 of the vehicle 102 and the communication unit 128 of the external server 106 to communicate application related data between one another (e.g., through the internet cloud). Additionally, the fueling behavior application 108 may utilize the communication unit 128 of the external server 106 to communicate application related data between the external server 106 and the POI computing infrastructure 136.

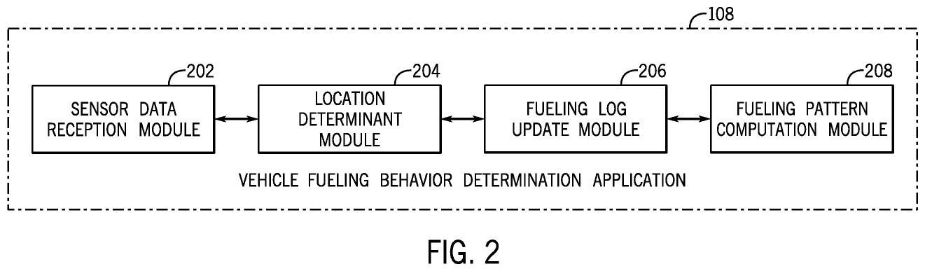

FIG. 2 is a schematic view of a plurality of modules 202-208 of the fueling behavior application 108 for determining fueling behavior with respect to the vehicle 102 according to an exemplary embodiment of the present disclosure. In an exemplary embodiment, the plurality of modules 202-208 may include a sensor data reception module 202, a location determinant module 204, a fueling log update module 206, and a fueling pattern computation module 208. It is appreciated that the fueling behavior application 108 may include one or more additional modules and/or sub-modules that are included in addition or in lieu of the modules 202-208.

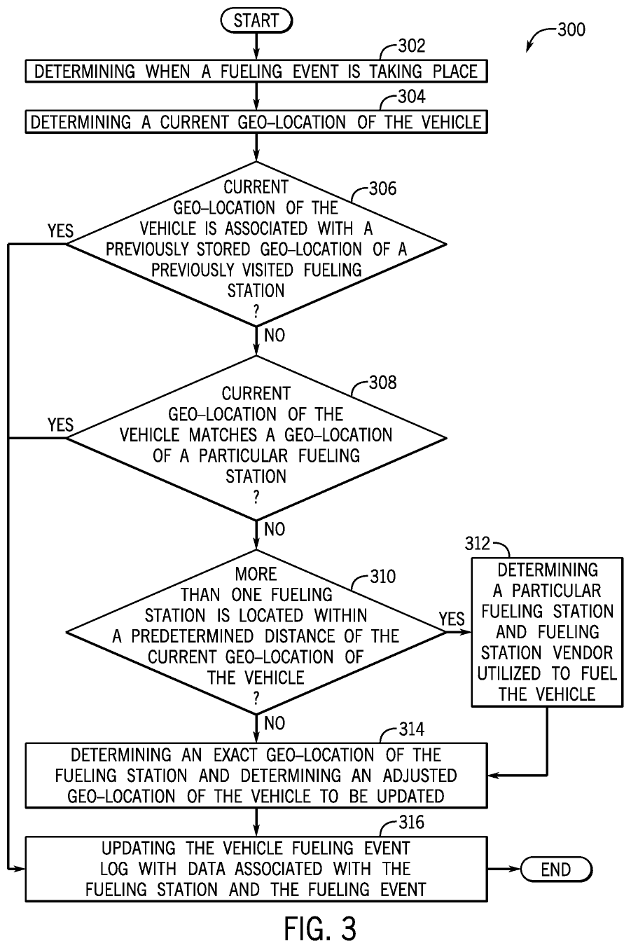

FIG. 3 is a process flow diagram of a method 300 of updating the vehicle fueling event log with data associated with a determined fueling station 120 and an associated fueling event according to an exemplary embodiment of the present disclosure. FIG. 3 will be described with reference to the components of FIG. 1 and FIG. 2, though it is to be appreciated that the method 300 of FIG. 3 may be used with additional and/or alternative system components. It is appreciated that the method 300 of FIG. 3 may be continually executed by the fueling behavior application 108 based on the determination that a fueling event is occurring.

The method 300 may begin at block 302, wherein the method 300 may include determining when a fueling event is occurring. In an exemplary embodiment, the sensor data reception module 202 of the fueling behavior application 108 may be configured to communicate with the ECU 104, the fuel sensors 122, and/or the GPS sensors 124 to receive receptive data that may be output by the ECU 104 and/or the sensors 122, 124. Such data may be analyzed by the sensor data reception module 202 and/or communicated to one or more additional modules 204-208 of the application 108 to be further analyzed and/or processed.

As discussed above, the fuel sensors 122 of the vehicle 102 may be configured to determine a real-time level of fuel that is stored within the fuel tank(s) of the vehicle 102. The fuel sensors 122 may additionally be configured to determine when the vehicle 102 is being fueled based on real-time sensing of an increase in the level of fuel within the fuel tank(s) of the vehicle 102. Upon determining that the vehicle 102 is being fueled, the fuel sensors 122 may communicate respective data regarding the fueling event to the sensor data reception module 202. The sensor data reception module 202 may thereby determine when the fueling event is occurring.

The method 300 may proceed to block 304, wherein the method 300 may include determining a current geo-location of the vehicle 102. In one embodiment, upon determining when the fueling event is occurring, the sensor data reception module 202 may communicate with the GPS sensors 124 to determine GPS coordinates and/or DGPS coordinates of a current real-time geo-location of the vehicle 102. The GPS sensors 124 may thereby communicate the GPS coordinates and/or DGPS coordinates to the sensor data reception module 202. In one embodiment, the sensor data reception module 202 may communicate the GPS/DGPS coordinates of the vehicle 102 to the location determinant module 204.

In one embodiment, the location determinant module 204 of the fueling behavior application 108 may be configured to analyze the GPS/DGPS coordinates of the vehicle 102 and determine the current geo-location of the vehicle 102. As discussed above, the current geo-location of the vehicle 102 may be included as geo-locational coordinates (e.g., values) that may pertain to latitude and longitude based geographical coordinates.

The method 300 may proceed to block 306, wherein the method 300 may include determining if the current geo-location of the vehicle 102 is associated with a previously stored geo-location of a previously visited fueling station 120. In one embodiment, the location determinant module 204 may access the vehicle fueling event log 132 to determine if the operator of the vehicle 102 has previously visited and utilized a previously visited fueling station 120 to fuel the vehicle 102. More specifically, the location determinant module 204 may access the vehicle fueling event log 132 stored on the memory 130 of the external server 106 to query the vehicle fueling event log 132.

The location determinant module 204 may query the vehicle fueling event log 132 for a record that includes geo-locational coordinates of a previously visited fueling station 120 that match the geo-locational coordinates associated with the current geo-location of the vehicle 102. In some circumstances, the location determinant module 204 may query the vehicle fueling event log 132 for a record that includes geo-locational coordinates of a previously visited fueling station 120 that match the adjusted geo-location of the vehicle 102 when such a record had been created during a past visit to the particular fueling station 120. In such circumstances, the adjusted geo-locational coordinates that are associated with the particular fueling station 120 may have been previously stored and associated with the (then current) geo-location of the vehicle 102 upon determining that the particular fueling station 120 was located within the predetermined distance of the geo-location of the vehicle 102 but not at an exact location of the geo-location of the vehicle 102.

In one configuration, if a record is found within the vehicle fueling event log 132 that includes the geo-locational coordinates that are associated with a fueling station 120 that match the current geo-location of the vehicle 102, the location determinant module 204 may determine that the current geo-location of the vehicle 102 is associated with a previously stored geo-location of a previously visited fueling station 120. In another configuration, if a record is found within the vehicle fueling event log 132 that includes the geo-locational coordinates that are associated with a fueling station 120 that match the previously stored adjusted geo-locational coordinates of the vehicle 102 that are associated with the current geo-location of the vehicle 102, the location determinant module 204 may determine that the current geo-location of the vehicle 102 is associated with a previously stored geo-location of a previously visited fueling station 120.

If it is determined that the current geo-location of the vehicle 102 is associated with a previously stored geo-location of a previously visited fueling station 120 (at block 306), the method 300 may proceed to block 316, wherein the method 300 may include updating the vehicle fueling event log 132 with data associated with the fueling station 120 and the fueling event. In an exemplary embodiment, upon determining that the current geo-location of the vehicle 102 is associated with a previously stored geo-location of a previously visited fueling station 120, the location determinant module 204 may be configured to communicate respective data to the fueling log update module 206 of the fueling behavior application 108.

In one embodiment, upon receiving data from the location determinant module 204 regarding the current geo-location of the vehicle 102 being associated with a previously stored geo-locational coordinates of a previously visited fueling station 120, the fueling log update module 206 may access the fueling station data repository 134 to determine the (current) fueling station vendor that owns and/or operates the fueling station 120 that is determined to be visited by the operator.

Upon determining the fueling station vendor that owns and/or operates the fueling station 120, the fueling log update module 206 may be configured to access the particular record associated with the previously visited fueling station 120 within the vehicle fueling event log 132 to store data that pertains to the determined fueling station 120 and the determined fueling station vendor (e.g., if the determined fueling station vendor is different than the previously stored fueling station vendor associated with the fueling station 120) that is utilized to fuel the vehicle 102. The fueling log update module 206 may also be configured to store a time stamp (e.g., date and time) associated with respective fueling event.

In one embodiment, the fueling log update module 206 may additionally be configured to communicate with the fuel sensors 122 to determine a remaining mileage range (value) and/or a remaining fuel level (value) of one or more fuel tanks of the vehicle 102 that may be sensed upon the fuel sensors 122 sensing that the fueling event is occurring. In an exemplary embodiment, the fueling log update module 206 may update the record pertaining to the previously visited fueling station 120 and/or the fueling station vendor that owns and/or operates the previously visited fueling station 120 with the current time stamp that is associated with the current fueling event that may be stored in addition to past time stamps during which the vehicle 102 was/is located at the previously visited fueling station 120 and/or utilizing the fueling station vendor that owns and/or operates the previously visited fueling station 120 to fuel the vehicle 102. Upon updating the vehicle fueling event log 132 with the current time stamp, the fueling log update module 206 may additionally update the record with the remaining mileage range, and/or the remaining fuel level. As discussed below, such data may be analyzed by the fueling pattern computation module 208 to compute the fueling pattern(s) associated with the operator of the vehicle 102.

Referring again to block 306, if it is determined that the geo-location of the vehicle 102 is not associated with a previously stored geo-location of a previously visited fueling station 120, the method 300 may proceed to block 308, wherein the method 300 may include determining if the current geo-location of the vehicle 102 matches a geo-location of a particular fueling station 120. In one embodiment, upon querying the vehicle fueling event log 132 and determining that the current geo-location of the vehicle 102 is not associated with a previously visited fueling station 120, the location determinant module 204 may be configured to access the fueling station data repository 134 stored on the memory 130 of the external server 106.

The location determinant module 204 may query the fueling station data repository with geo-locational coordinates that correspond to the current geo-location of the vehicle 102 to determine if the current geo-location of the vehicle 102 matches geo-locational coordinates of a particular fueling station 120 that may be utilized for a first time to fuel the vehicle 102. As discussed above, the fueling station data repository 134 may be populated based on data communicated from the POI computing infrastructure 136. Accordingly, fueling station data that includes real-time and up to date geo-location data including geo-locational coordinates pertaining to the one or more particular fueling stations 120 operated by particular fueling vendors may be continually updated upon the fueling station data repository 134.

In one embodiment, upon querying the fueling station data repository 134 with the geo-locational coordinates that correspond to the current geo-location of the vehicle 102, if the location determinant module 204 determines a particular fueling station 120 is located at the current geo-location of the vehicle 102, the location determinant module 204 may retrieve a name/description of the fueling station 120 and a fueling station vendor that owns and/or operates the fueling station 120.

If it is determined that the current geo-location of the vehicle 102 matches the geo-location coordinates of a particular fueling station 120 (at block 308), the method 300 may proceed to block 316, wherein the method 300 may include updating the vehicle fueling event log 132 with the data associated with the fueling station 120 and the fueling event. In an exemplary embodiment, upon determining that the current geo-location of the vehicle 102 matches the geo-locational coordinates of a particular fueling station 120, the location determinant module 204 may be configured to communicate data pertaining to the name/description of the fueling station 120 and a fueling station vendor that owns and/or operates the fueling station 120 to the fueling log update module 206. The location determinant module 204 may additionally be configured to communicate data that pertaining to the geo-location of the fueling station 120 in the form of geo-locational coordinates.

In one embodiment, the fueling log update module 206 may additionally be configured to communicate with the fuel sensors 122 to determine a remaining mileage range (value) and/or a remaining fuel level (value) of one or more fuel tanks of the vehicle 102 that may be sensed upon the fuel sensors 122 sensing that the fueling event is occurring at the fueling station 120. In one or more embodiments, upon receiving data pertaining to the fueling station 120 utilized to fuel the vehicle 102 and the fueling event from the location determinant module 204 and/or data associated with the remaining mileage range and/or remaining fuel level from the fuel sensors 122, the fueling log update module 206 may be configured to access the vehicle fueling event log 132 stored on the memory 130 of the external server 106 to create a new record that may be associated with the fueling station 120 and the fueling event occurring at the fueling station 120 (as determined at block 308). Upon creating the record within the vehicle fueling event log 132, the fueling log update module 206 may be configured to update the newly created record associated with the particular fueling station 120 and the fueling event with data associated with the geo-locational coordinates of the fueling station 120.

The newly created record may also be updated with data associated with the name of the fueling station vendor that owns and/or operates the fueling station 120 utilized to fuel the vehicle 102 and a current time stamp associated with the current fueling event (e.g., date and time of the current fueling event). Upon updating the vehicle fueling event log 132 with the data associated with the fueling station vendor and the current time stamp, the fueling log update module 206 may additionally update the record with the remaining mileage range, and/or the remaining fuel level. As discussed below, such data may be analyzed by the fueling pattern computation module 208 to compute the fueling pattern(s) associated with the operator of the vehicle 102.

With reference again to block 308, if it is determined that the current geo-location of the vehicle 102 does not match a geo-location of a particular fueling station 120, the method 300 may proceed to block 310, wherein the method 300 may include determining if more than one fueling station 120 is located within a predetermined distance of the current geo-location of the vehicle 102. In an exemplary embodiment, the location determinant module 204 may be configured to access the fueling station data repository 134 to query the fueling station data repository 134 with a plurality of geo-locational coordinates that correspond to one or more points of interest that are located within the predetermined distance (e.g., 3000 feet) of the vehicle 102 to determine one or more fueling stations 120 that may be located within the predetermined distance of the current location of the vehicle 102.

Stated differently, since the current geo-location of the vehicle 102 does not match to an exact geo-location of a fueling station 120 (as determined at block 308), based on data provided by the GPS sensors 124 (e.g., the geo-location may be associated with another point of interest near the vehicle 102), the location determinant module 204 may query the fueling station data repository 134 to determine one or more fueling stations 120 that may be located within the predetermined distance of the current geo-location of the vehicle 102. As discussed below, this determination may be used to further determine a particular fueling station 120 being utilized to fuel the vehicle 102.

Upon querying the fueling station data repository 134 with the geo-locational coordinates associated with one or more points of interest that are located within a predetermined distance of the current geo-location of the vehicle 102, the location determinant module 204 may determine if one or more than one fueling station 120 is located within the predetermined distance of the vehicle 102 based on fueling station data retrieved from the fueling station data repository 134. If the location determinant module 204 determines that more than one fueling station 120 is determined to be located within the predetermined distance of the vehicle 102 (e.g., two fueling stations are located within a predetermined distance of the geo-location of the vehicle 102) (at block 310), the method 300 may proceed to block 312, wherein the method 300 may include determining a particular fueling station 120 and fueling station vendor utilized to fuel the vehicle 102.

In one embodiment, if more than one fueling station 120 is located within the predetermined distance of the current geo-location of the vehicle 102, the location determinant module 204 may be configured to analyze the POI favorite list 112 stored on the storage unit 110 of the vehicle 102 to determine if the vehicle 102 is being fueled at a particular fueling station 120 that may be previously selected as a favorite point of interest that is favored by the operator of the vehicle 102. Accordingly, the location determinant module 204 may determine that the vehicle 102 is being fueled at the particular fueling station 120 that is included within the POI favorite list 112 and that is within the predetermined distance of the current geo-location of the vehicle 102.

In another embodiment, the location determinant module 204 may additionally or alternatively be configured to communicate with the portable device(s) that may be carried by the operator that may be used to provide electronic payment for fuel to determine a particular fueling station 120 and associated fueling station vendor that is being utilized to fuel the vehicle 102 if more than one fueling station 120 is located within the predetermined distance of the current geo-location of the vehicle 102. In an additional embodiment, the location determinant module 204 may be configured to communicate with a credit card and/or banking institution that may be linked by the operator (via one or more interfaces of the application 108) and may be utilized to provide electronic payment for fuel to determine a particular fueling station 120 and associated fueling vendor that is being utilized to fuel the vehicle 102 if more than one fueling station 120 is located within the predetermined distance of the current geo-location of the vehicle 102.

In one or more configurations, when a particular fueling station 120 is determined to be utilized to fuel the vehicle 102 when more than one fueling station 120 is determined to be located within the predetermined distance of the current geo-location of the vehicle 102, the location determinant module 204 may be configured to adjust the geo-locational coordinates associated with the current geo-location of the vehicle 102 based on data provided by the GPS sensors 124 to thereby determine adjusted geo-locational coordinates that are associated with the current geo-location of the vehicle 102. In particular, the adjusted geo-locational coordinates may match the exact geo-locational coordinates of the fueling station 120 being utilized to fuel the vehicle 102. Accordingly, during subsequent trips to the fueling station 120, the application 108 may retrieve the stored adjusted geo-locational coordinates based on the geo-locational coordinates of the current geo-location of the vehicle 102 to efficiently determine that the vehicle 102 is located at the particular fueling station 120 based on the current geo-location of the vehicle 102.

In one or more embodiments, the location determinant module 204 may be configured to communicate data regarding the adjusted geo-location of the vehicle 102 that are associated with the current geo-locational coordinates of the vehicle 102 and that correspond to the geo-locational coordinates of the particular fueling station 120 that is determined to be utilized to fuel the vehicle 102 to the fueling log update module 206. In one configuration, upon receiving data from the location determinant module 204 regarding the particular fueling station 120 being utilized to fuel the vehicle 102, the fueling log update module 206 may access the fueling station data repository 134 to determine and/or confirm the (current) fueling station vendor that owns and/or operates the fueling station 120 that is determined to be utilized to fuel the vehicle 102 when more than one fueling station 120 is located within the predetermined distance of the vehicle 102.

Referring again to block 310, if it is determined that more than one fueling station 120 is not located within the predetermined distance of the current geo-location of the vehicle 102, the location determinant module 204 may thereby determine that a single fueling station 120 is located within the predetermined distance of the current geo-location of the vehicle 102. The method 300 may thereby proceed to block 314, wherein the method 300 may include determining an exact geo-location of the fueling station 120 and determining an adjusted geo-location of the vehicle 102 to be updated.

In an exemplary embodiment, the location determinant module 204 may be configured to access the fueling station data repository 134 to query the fueling station data repository 134 with geo-locational coordinates that correspond to a plurality of geo-locational coordinates that correspond to one or more points of interest that are located within the predetermined distance (e.g., 3000 feet) of the vehicle 102 to determine the fueling station 120 that is located within the predetermined distance of the current location of the vehicle 102.

Stated differently, since the current geo-location of the vehicle 102 does not match to an exact geo-location of a fueling station 120 (as determined at block 308), based on data provided by the GPS sensors 124 (e.g., the geo-location may be associated with another point of interest near the vehicle 102), and it is determined that more than one fueling station 120 is not located within the predetermined distance of the current geo-location of the vehicle 102 (at block 310), the location determinant module 204 may query the fueling station data repository 134 to determine a particular fueling station 120 that may be located within the predetermined distance of the current geo-location of the vehicle 102.

Upon querying the fueling station data repository 134 with the current geo-locational coordinates of the vehicle 102 and the geo-locational coordinates associated with one or more points of interest that are located within a predetermined distance of the current geo-location of the vehicle 102, the location determinant module 204 may determine data associated with the particular fueling station 120 that is located within the predetermined distance of the vehicle 102. Such data may include the name of the fueling station 120 and the fueling station vendor that owns and/or operates the particular fueling station 120.

In one or more configurations, when the particular fueling station 120 that is located within the predetermined distance of the current geo-location of the vehicle 102 is determined to be utilized to fuel the vehicle 102, the location determinant module 204 may be configured to determine an adjusted geo-location of the vehicle 102 that is associated with the current geo-location of the vehicle 102 and that matches the geo-location of the fueling station 120 being utilized to fuel the vehicle 102. In particular, the location determinant module 204 may be configured to adjust the geo-locational coordinates associated with the current geo-location of the vehicle 102 based on data provided by the GPS sensors 124 to thereby determine the adjusted geo-locational coordinates that are associated with the current geo-location of the vehicle 102.

More specifically, the geo-location coordinates that are associated with the current geo-location of the vehicle 102 may be adjusted to match the exact geo-locational coordinates of the particular fueling station 120. In one configuration, the adjusted geo-locational coordinates and the associated geo-locational coordinates of the current geo-location of the vehicle 102 may be stored within the vehicle fueling event log 132. Accordingly, during subsequent trips to the fueling station 120, the application 108 may retrieve the stored adjusted geo-locational coordinates based on the geo-locational coordinates of the current geo-location of the vehicle 102 to efficiently determine that the vehicle 102 is located at the particular fueling station 120 based on the current geo-location of the vehicle 102.

In one or more embodiments, the location determinant module 204 may be configured to communicate data regarding the adjusted geo-location of the vehicle 102 that are associated with the current geo-locational coordinates of the vehicle 102 and that correspond to the geo-locational coordinates of the particular fueling station 120 that is determined to be utilized to fuel the vehicle 102 to the fueling log update module 206. In one configuration, upon receiving data from the location determinant module 204 regarding the particular fueling station 120 being utilized to fuel the vehicle 102, the fueling log update module 206 may access the fueling station data repository 134 to determine the fueling station vendor that owns and/or operates the fueling station 120 that is determined to be utilized to fuel the vehicle 102. The location determinant module 204 may also be configured to communicate data regarding the adjusted geo-location of the vehicle 102 that are associated with the current geo-locational coordinates of the vehicle 102 and that correspond to the geo-locational coordinates of the particular fueling station 120 that is determined to be utilized to fuel the vehicle 102 to the fueling log update module 206.

Upon determining the adjusted geo-location of the vehicle 102 that matches the geo-locational coordinates of the fueling station vendor (at block 312 or block 314), the method 300 may proceed to block 316, wherein the method 300 may include updating the vehicle fueling event log 132 with data associated with the fueling station 120 and the fueling event. In an exemplary embodiment, upon determining that the adjusted geo-location of the vehicle 102 based on the geo-locational coordinates associated with the fueling station 120 that is determined to be utilized to fuel the vehicle 102, the fueling log update module 206 may additionally be configured to communicate with the fuel sensors 122 to determine data associated with a time stamp of the fueling event, a remaining mileage range (value) and/or a remaining fuel level (value) of one or more fuel tanks of the vehicle 102 that may be sensed upon the fuel sensors 122 sensing that the fueling event is occurring at the fueling station 120.

In one embodiment, upon receiving data pertaining to the particular fueling station 120 utilized to fuel the vehicle 102 and the fueling event from the location determinant module 204 and/or data associated with the time stamp, the remaining mileage range and/or the remaining fuel level, the fueling log update module 206 may be configured to access the vehicle fueling event log 132 stored on the memory 130 of the external server 106 to create a new record that may be associated with the fueling station 120 and the fueling event occurring at the fueling station 120. Upon creating the record within the vehicle fueling event log 132, the fueling log update module 206 may be configured to update the newly created record associated with the fueling station 120 and the fueling event with data associated with the geo-locational coordinates of the fueling station 120 and/or the adjusted current geo-location in the form of adjusted geo-locational coordinates of the vehicle 102 that are associated with the geo-locational coordinates of the current geo-location of the vehicle 102.

The newly created record may also be updated with data associated with the name of the fueling station vendor that owns and/or operates the fueling station 120 and the current time stamp associated with the current fueling event (e.g., date and time of the current fueling event. Upon updating the vehicle fueling event log 132 with the current time stamp, the fueling log update module 206 may additionally update the record with the remaining mileage range, and/or the remaining fuel level. As discussed below, such data may be analyzed by the fueling pattern computation module 208 to compute the fueling pattern(s) associated with the operator of the vehicle 102.

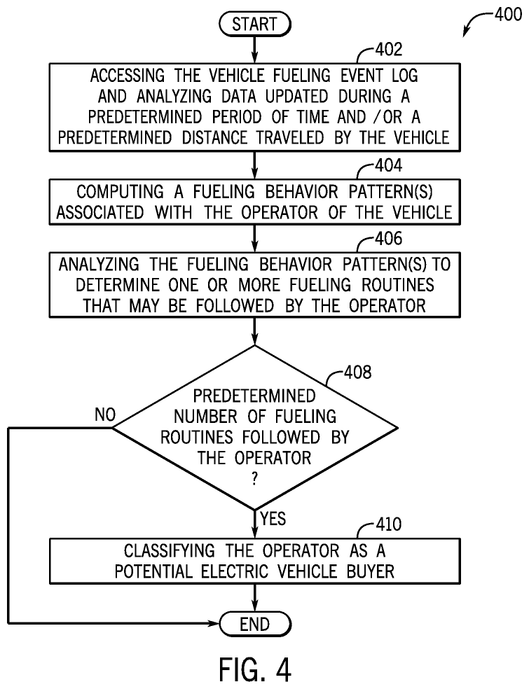

FIG. 4 is a process flow diagram of a method 400 of computing a fueling behavior pattern and analyzing the fueling behavior pattern according to an exemplary embodiment of the present disclosure. FIG. 4 will be described with reference to the components of FIG. 1 and FIG. 2, though it is to be appreciated that the method 400 of FIG. 4 may be used with additional and/or alternative system components. It is appreciated that the method 400 of FIG. 4 may be continually executed by the fueling behavior application 108 based on the determination that a predetermined period of time has passed and/or a predetermined distance has been traveled by the vehicle 102.

The method 400 may begin at block 402, wherein the method 400 may include accessing the vehicle fueling event log 132 and analyzing data updated during a predetermined period of time. In an exemplary embodiment, the fueling pattern computation module 208 of the fueling behavior application 108 may be configured to communicate with the ECU 104 of the vehicle 102 to determine when the vehicle 102 is driven for a predetermined period of time (e.g., 300 hours) and/or a predetermined distance has been traveled by the vehicle 102 (e.g., 5000 miles). Upon determining that the vehicle 102 is driven for a predetermined period of time and/or a predetermined distance has been traveled by the vehicle 102, the fueling pattern computation module 208 may be configured to access the vehicle fueling event log 132 stored upon the memory 130 of the external server 106.

The fueling pattern computation module 208 may be configured to query the vehicle fueling event log 132 for records that may be associated with particular fueling events that take place at one or more fueling stations 120 that occur during the predetermined period of time and/or during a course of time that the predetermined distance is traveled by the vehicle 102. In particular, the fueling pattern computation module 208 may be configured to query the vehicle fueling event log 132 to retrieve records that include timestamps that pertain to the predetermined period of time and/or the course of time that the predetermined distance is traveled by the vehicle 102.

Upon retrieving the respective records, the fueling pattern computation module 208 may analyze data previously updated within the records that are associated with every fueling station 120 and every fueling event (as previously updated based on execution of the block 316 of the method 300 of FIG. 3) that occurred during the predetermined period of time and/or during the course of time that the predetermined distance is traveled by the vehicle 102.

The method 400 may proceed to block 404, wherein the method 400 may include computing a fueling behavior pattern(s) associated with the operator of the vehicle 102. In an exemplary embodiment, the fueling pattern computation module 208 may analyze data within the retrieved records that are associated with every fueling station 120 and every fueling event that occurred during the predetermined period of time and/or during the course of time that the predetermined distance is traveled by the vehicle 102 to determine one or more data points. The one or more data points may be categorized in one or more categories that may be associated with the fueling events.

In one embodiment, the one or more data points may be determined and categorized with respect to the fueling station(s) 120 that may have been utilized to fuel the vehicle 102 during each of the fueling events, the fueling station vendor(s) that own and/or operate the fueling stations 120 that may have been utilized for each of the fueling events, and/or the geo-location(s) of the fueling station(s) 120 that may have been utilized for each of the fueling events. Additionally, the one or more data points may be determined and categorized with respect to time stamps associated with the timeframes of each of the fueling events that are determined to occur by the sensor data reception module 202. In some embodiments, the one or more data points may also be determined and categorized with respect to the remaining mileage range of the vehicle 102 and/or the remaining fuel level of the fuel tank(s) of the vehicle 102 as determined during the start of each of the fueling events.

In an exemplary embodiment, upon determining the one or more data points and categorizing the one or more data points, the fueling pattern computation module 208 may compute the fueling behavior pattern(s) that includes data that charts patterns of data points of one or more respective categories over the course of the predetermined period of time and/or during the course of time that the predetermined distance is traveled by the vehicle 102.

As an illustrative example, the fueling behavior pattern(s) may be configured as a data packet that includes data that charts patterns of data points associated with the fueling station(s) 120 utilized to fuel the vehicle 102 at particular time frames and/or at particular geo-locations. Additionally, the fueling behavior pattern(s) may include data that charts patterns of data points associated with fueling station vendor(s) that own and/or operate the fueling station(s) 120 utilized to fuel the vehicle 102 at particular time frames and/or at particular geo-locations. The fueling behavior pattern(s) may also include data that charts patterns of data points associated with remaining mileage ranges and/or the remaining fuel levels as determined during the start of each of the fueling events that occurred during the predetermined period of time and/or during the course of time that the predetermined distance is traveled by the vehicle 102.

The method 400 may proceed to block 406, wherein the method 400 may include analyzing the fueling behavior pattern(s) to determine one or more fueling routines that may be followed by the operator. In an exemplary embodiment, upon computing the fueling behavior pattern(s) that may be associated with the operator of the vehicle 102, the fueling pattern computation module 208 may analyze the fueling behavior pattern(s) to determine if the operator follows one or more fueling routines that may be associated with but may not be limited to one or more particular fueling stations 120 that may be utilized to fuel the vehicle 102, one or more particular fueling station vendors that may own and/or operate the fueling station(s) 120 that may be utilized to fuel the vehicle 102, one or more timeframes that may be preferred by the operator to fuel the vehicle 102, one or more geo-locations of one or more fueling stations 120 that are utilized to fuel the vehicle 102, one or more respective remaining mileage ranges and/or one or more respective remaining fuel levels at which the vehicle 102 may be fueled, and the like. In particular, the patterns of data points included within the fueling behavior pattern(s) may be analyzed to determine if the operator is prone to following one or more fueling routines with respect to fueling of the vehicle 102.

The method 400 may proceed to block 408, wherein the method 400 may include determining if a predetermined number of fueling routines are followed by the operator. In an exemplary embodiment, the fueling pattern computation module 208 may evaluate the number of fueling routines that may be determined as being followed by the operator (at block 406) to determine if the number of fueling routines followed by the operator of the vehicle 102 meet or surpass a predetermined routine number threshold.

The predetermined routine number threshold may include a predetermined value that pertains to a requisite number of fueling routines that pertain to fueling and/or fuel purchasing patterns with respect to one or more particular fueling stations 120, one or more particular fueling station vendors and/or that may be related to a frequency of fueling, remaining mileage ranges of the vehicle 102, and/or remaining fuel levels of the fuel tank(s) of the vehicle 102 that may be analyzed by the application 108, the OEM, and/or the third-party entity. The predetermined routine number threshold may be used to predict that the operator may be a candidate that is likely to follow electric charging schedules and/or routines. In other words, the predetermined routine number threshold may include a predetermined value that pertains to a requisite number of fueling routines that may enable the fueling pattern computation module 208 to classify the operator as a potential electric vehicle buyer.

If it is determined that the predetermined number of fueling routines are followed by the operator (at block 408), the method 400 may proceed to block 410, wherein the method 400 may include classifying the operator as a potential electric vehicle buyer. In one embodiment, if the fueling pattern computation module 208 determines that the number of fueling routines followed by the operator of the vehicle 102 meets or surpasses a predetermined routine number threshold and accordingly determines that the predetermined number of fueling routines is followed by the operator of the vehicle 102, the module 208 may classify the operator of the vehicle 102 as a potential electric vehicle buyer.

In one configuration, upon classifying the operator of the vehicle 102, the fueling pattern computation module 208 may communicate data pertaining to the classification of the potential electric vehicle buyer to the OEM and/or the third party entity through wireless communications that may occur through the communication unit 128 and/or the communication unit 118 (via the internet cloud). In another embodiment, upon classifying the operator of the vehicle 102, the fueling pattern computation module 208 may communicate with the head unit 114 to operably control the display unit 116 to present one or more interfaces of the fueling behavior application 108 within the vehicle 102.

In one embodiment, the one or more interfaces of the fueling behavior application 108 may also include one or more fueling behavior interfaces that may also be presented to the operator of the vehicle 102 through the display unit 116. The one or more fueling behavior interfaces may be presented to allow the operator to view data pertaining to one or more fueling behavior patterns that may be computed by the application 108 to be analyzed by the operator. In another embodiment, the one or more interfaces of the fueling behavior application 108 may additionally include one or more promotional interfaces that may be presented to the operator of the vehicle 102 with promotional information pertaining to the purchase of one or more goods and/or services. Such promotional information may be based on data that may be provided by the OEM and/or the third party entity upon analysis of one or more fueling behavior patterns that may be associated with the operator of the vehicle 102.

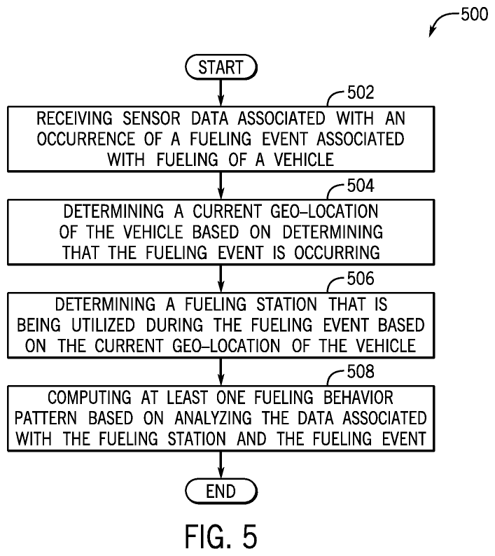

FIG. 5 is a process flow diagram of a method 500 for determining vehicle fueling behavior according to an exemplary embodiment of the present disclosure. FIG. 5 will be described with reference to the components of FIG. 1 and FIG. 2, though it is to be appreciated that the method 500 of FIG. 5 may be used with additional and/or alternative system components. The method 500 may begin at block 502, wherein the method 500 includes receiving sensor data associated with an occurrence of a fueling event associated with fueling of a vehicle 102.

The method 500 may proceed to block 504, wherein the method 500 may include determining a current geo-location of the vehicle 102 based on determining that the fueling event is occurring. The method 500 may proceed to block 506, wherein the method 500 may include determining a fueling station that is being utilized during the fueling event based on the current geo-location of the vehicle 102. In one embodiment, data is stored that is associated with the at least one fueling station and the fueling event. The method 500 may proceed to block 508, wherein the method 500 may include computing at least one fueling behavior pattern based on analyzing the data associated with the fueling station and the fueling event.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for determining vehicle fueling behavior, comprising:
receiving sensor data associated with an occurrence of a fueling event associated with fueling of a vehicle;
determining a current geo-location of the vehicle based on determining that the fueling event is occurring;
determining a fueling station that is being utilized during the fueling event that is located at the current geo-location of the vehicle, wherein an adjusted geo-location of the vehicle is determined that matches a geo-location of the fueling station that is located within a predetermined distance of the current geo-location of the vehicle when it is determined that a geo-location of the fueling station that is being utilized during the fueling event does not match with the determined current geo-location of the vehicle, wherein data that includes the adjusted geo-location of the vehicle is electronically stored and is associated with the fueling station and the fueling event; and
computing at least one fueling behavior pattern based on analyzing the data associated with the fueling station and the fueling event, wherein a display unit of the vehicle is operably controlled to present at least one interface that pertains to information that is based on the at least one fueling behavior pattern.

2. The computer-implemented method of claim 1, wherein receiving sensor data associated with the fueling event includes communicating with fuel sensors of the vehicle and receiving data from the fuel sensors regarding the occurrence of the fueling event based on the fuel sensors sensing a rise in a level of fuel within at least one fuel tank of the vehicle.

3. The computer-implemented method of claim 1, wherein determining the current geo-location of the vehicle includes receiving GPS coordinates from GPS sensors of the vehicle and analyzing the GPS coordinates of the vehicle to determine geo-locational coordinates that are associated with the current geo-location of the vehicle.

4. The computer-implemented method of claim 3, wherein determining the fueling station that is being utilized during the fueling event includes determining if the vehicle is located at a previously visited fueling station that is located at the current geo-location of the vehicle, wherein data is stored that is associated with the previously visited fueling station and the fueling event upon determining that the geo-locational coordinates that are associated with the current geo-location of the vehicle match previously stored geo-locational coordinates of the previously visited fueling station.

5. The computer-implemented method of claim 4, wherein determining the fueling station that is being utilized during the fueling event includes determining if the vehicle is located at a fueling station that is located at the current geo-location of the vehicle upon determining that the fueling event is not occurring at the previously visited fueling station, wherein data is stored that is associated with the fueling station located at the current geo-location of the vehicle and the fueling event upon determining that the geo-locational coordinates that are associated with the current geo-location of the vehicle match geo-locational coordinates of the fueling station that is located at the current geo-location of the vehicle.

6. The computer-implemented method of claim 1, wherein determining the fueling station that is being utilized during the fueling event includes determining that more than one fueling station is located within the predetermined distance of the current geo-location of the vehicle, wherein electronic payment information is analyzed to determine the fueling station that is being utilized during the fueling event and the adjusted geo-location of the vehicle is determined that matches the geo-location of the fueling station, wherein the adjusted geo-location of the vehicle is stored to be utilized during at least one subsequent trip to the fueling station to determine a fueling station vendor that owns or operates the fueling station.

7. The computer-implemented method of claim 1, wherein the data that includes is aociatcd with the adjusted geo-location of the vehicle is retrieved during at least one subsequent trip to the fueling station based on the determined current geo-location of the vehicle to determine that the fueling event is occurring at a previously visited fueling station.

8. The computer-implemented method of claim 7, wherein computing at least one fueling behavior pattern includes analyzing the data associated with the fueling station and the fueling event that is stored for a predetermined period of time and determining a plurality of data points that are associated with the fueling station and the fueling event.

9. The computer-implemented method of claim 1, further including analyzing the at least one fueling behavior pattern to determine if a predetermined number of fueling routines are followed with respect to fueling the vehicle, wherein an operator of the vehicle is classified as a potential electric vehicle buyer if the predetermined number of fueling routines are followed.

10. A system for determining vehicle fueling behavior, comprising:
a memory storing instructions when executed by a processor cause the processor to:
receive sensor data associated with an occurrence of a fueling event associated with fueling of a vehicle;
determine a current geo-location of the vehicle based on determining that the fueling event is occurring;
determine a fueling station that is being utilized during the fueling event that is located at the current geo-location of the vehicle, wherein an adjusted geo-location of the vehicle is determined that matches a geo-location of the fueling station that is located within a predetermined distance of the current geo-location of the vehicle when it is determined that a geo-location of the fueling station that is being utilized during the fueling event does not match with the determined current geo-location of the vehicle, wherein data that includes the adjusted geo-location of the vehicle is electronically stored and is associated with the fueling station and the fueling event; and
compute at least one fueling behavior pattern based on analyzing the data associated with the fueling station and the fueling event, wherein a display unit of the vehicle is operably controlled to present at least one interface that pertains to information that is based on the at least one fueling behavior pattern.

11. The system of claim 10, wherein receiving sensor data associated with the fueling event includes communicating with fuel sensors of the vehicle and receiving data from the fuel sensors regarding the occurrence of the fueling event based on the fuel sensors sensing a rise in a level of fuel within at least one fuel tank of the vehicle.

12. The system of claim 10, wherein determining the current geo-location of the vehicle includes receiving GPS coordinates from GPS sensors of the vehicle and analyzing the GPS coordinates of the vehicle to determine geo-locational coordinates that are associated with the current geo-location of the vehicle.

13. The system of claim 12, wherein determining the fueling station that is being utilized during the fueling event includes determining if the vehicle is located at a previously visited fueling station that is located at the current geo-location of the vehicle, wherein data is stored that is associated with the previously visited fueling station and the fueling event upon determining that the geo-locational coordinates that are associated with the current geo-location of the vehicle match previously stored geo-locational coordinates of the previously visited fueling station.

14. The system of claim 13, wherein determining the fueling station that is being utilized during the fueling event includes determining if the vehicle is located at a fueling station that is located at the current geo-location of the vehicle upon determining that the fueling event is not occurring at the previously visited fueling station, wherein data is stored that is associated with the fueling station located at the current geo-location of the vehicle and the fueling event upon determining that the geo-locational coordinates that are associated with the current geo-location of the vehicle match geo-locational coordinates of the fueling station that is located at the current geo-location of the vehicle.

15. The system of claim 10, wherein determining the fueling station that is being utilized during the fueling event includes determining that more than one fueling station is located within the predetermined distance of the current geo-location of the vehicle, wherein electronic payment information is analyzed to determine the fueling station that is being utilized during the fueling event and the adjusted geo-location of the vehicle is determined that matches the geo-location of the fueling station, wherein the adjusted geo-location of the vehicle is stored to be utilized during at least one subsequent trip to the fueling station to determine a fueling station vendor that owns or operates operators the fueling station.

16. The system of claim 10, wherein the data that includes the adjusted geo-location of the vehicle is retrieved during at least one subsequent trip to the fueling station based on the determined current geo-location of the vehicle to determine that the fueling event is occurring at a previously visited fueling station.

17. The system of claim 16, wherein computing at least one fueling behavior pattern includes analyzing the data associated with the fueling station and the fueling event that is stored for a predetermined period of time and determining a plurality of data points that are associated with the fueling station and the fueling event.

18. The system of claim 10, further including analyzing the at least one fueling behavior pattern to determine if a predetermined number of fueling routines are followed with respect to fueling the vehicle, wherein an operator of the vehicle is classified as a potential electric vehicle buyer if the predetermined number of fueling routines are followed.

19. A non-transitory computer readable storage medium storing instructions that when executed by a computer, which includes a processor perform a method, the method comprising:
receiving sensor data associated with an occurrence of a fueling event associated with fueling of a vehicle;
determining a current geo-location of the vehicle based on determining that the fueling event is occurring;
determining a fueling station that is being utilized during the fueling event that is located at the current geo-location of the vehicle, wherein an adjusted geo-location of the vehicle is determined that matches a geo-location of the fueling station that is located within a predetermined distance of the current geo-location of the vehicle when it is determined that a geo-location of the fueling station that is being utilized during the fueling event does not match with the determined current geo-location of the vehicle, wherein data that includes the adjusted geo-location of the vehicle is electronically stored and is associated with the fueling station and the fueling event; and
computing at least one fueling behavior pattern based on analyzing the data associated with the fueling station and the fueling event, wherein a display unit of the vehicle is operably controlled to present at least one interface that pertains to information that is based on the at least one fueling behavior pattern.

20. The non-transitory computer readable storage medium of claim 19, further including analyzing the at least one fueling behavior pattern to determine if a predetermined number of fueling routines are followed with respect to fueling the vehicle, wherein an operator of the vehicle is classified as a potential electric vehicle buyer if the predetermined number of fueling routines are followed.
